(19) United States
(12) Patent Application Publication
(10) Pub. No.: US 2026/0259437 A1
(43) Pub. Date: Sep. 3, 2026

(54) OPTICAL WAVEGUIDE ELEMENT, AND OPTICAL MODULATION DEVICE AND OPTICAL TRANSMISSION APPARATUS USING SAME

(71) Applicant: SUMITOMO OSAKA CEMENT CO., LTD., Tokyo (JP)

(72) Inventors: Yuki KUGIMOTO, Tokyo (JP); Yumi MURATA, Tokyo (JP)

(73) Assignee: SUMITOMO OSAKA CEMENT CO., LTD., Tokyo (JP)

(21) Appl. No.: 18/846,600

(22) PCT Filed: Mar. 30, 2022
(86) PCT No.: PCT/JP2022/016212

§ 371 Date: Sep. 12, 2024

(51) Int. Cl. G02F 1/035

(52) U.S. Cl. CPC G02F 1/035; G02F 2201/122

(57) ABSTRACT

An object of the present invention is to provide an optical waveguide device which is configured such that an adhesive does not flow into a space between electrodes and the like when a fixed member is bonded to a substrate and in which propagation loss of an optical waveguide or the like is reduced. An optical waveguide device includes a substrate (1) on which an optical waveguide is formed; an electrode (3G, 3S, 3B) formed on the substrate (1); and a fixed member (4, 5) fixed on the substrate (1) through an adhesive (AD), in which a structure (WL3 to WL7) protruding on the substrate (1) is disposed, and the structure (WL3 to WL7) is continuously disposed to divide an upper surface of the substrate (1) into two regions, and a slit that connects the two regions is provided at an intermediate portion (between WL3 and WL4) of the structure (WL3 to WL7) or between the structure (WL3) and an end portion (E1) of the substrate (1).

### TECHNICAL FIELD

The present invention relates to an optical waveguide device, and an optical modulation device and an optical transmission apparatus using the same, and particularly to an optical waveguide device including a substrate on which an optical waveguide is formed, an electrode formed on the substrate, and a fixed member fixed on the substrate through an adhesive.

### BACKGROUND ART

In the field of optical measurement technology or in the field of optical communication technology, optical waveguide devices such as an optical modulator using a substrate, such as lithium niobate (LN) or the like, having an electro-optic effect and the like have been widely used. Many of such optical waveguide devices have a signal electrode for performing optical modulation on an optical waveguide substrate, and an electrode for adjusting a bias in each waveguide, and have a shape, a gap between electrodes, and the like adjusted to optimize electrical characteristics such as propagation velocity of a microwave, impedance, and the like.

Since the optical waveguide device having such a configuration is joined to an attachment member such as an optical fiber, a lens, or the like, the optical waveguide device includes a fixed member, which is fixed on an electro-optical substrate through an adhesive, such as a holding member disposed on an end surface of the electro-optical substrate by being overlapped with the substrate, a light-receiving element for monitoring output light or radiated light of the optical waveguide, or the like.

One of the problems from the related art is that, as shown in FIG. 1 or 2, when fixed members (a holding member 5 and a light-receiving element 4) are fixed on an electro-optical substrate 1, an adhesive AD flows into a space between electrodes 3, changing a dielectric constant between the electrodes, which deteriorates electrical characteristics or decreases a withstand voltage. In FIGS. 1 and 2, a plurality of optical waveguide devices are incorporated into an LN wafer substrate, various fixed members are bonded to the substrate, and then the optical waveguide devices are cut at positions of alternate long and short dash lines A1, A2, and B1 to B3 to form individual optical waveguide devices (chips). A reference numeral 2 indicates the optical waveguide.

In response to this problem, Patent Literature No. 1 discloses that a dummy electrode is provided between an input portion of an optical waveguide and a signal electrode, and a joined portion of a holding member, to prevent an adhesive from flowing into the signal electrode by using the dummy electrode as an embankment. However, in this method, the dummy electrode spans the optical waveguide, resulting in optical absorption loss in that portion, and additionally, during chip cutting, a blade of a dicing saw cuts through a metal-formed portion of the dummy electrode, causing the blade to clog and leading to defective cutting.

In addition, in the optical waveguide device, in the light-receiving element for monitoring output light, which is fixed through an adhesive, as in Patent Literature No. 2, it is disclosed to provide a protruding portion to prevent an unnecessary adhesive from flowing into the light-receiving element installation portion and to reduce a deterioration in light-receiving accuracy. In addition, it is also disclosed to form a groove on the substrate and to configure the substrate such that the adhesive does not spread.

In Patent Literature No. 3, a guard pattern formed of gold or the like is disposed to surround the light-receiving element for the purpose of protecting the light-receiving element from unnecessary surface elastic waves.

With this guard pattern, a part of monitoring light was also absorbed, making it difficult for the light-receiving element to obtain sufficient light intensity.

In addition, in recent years, there has been a demand for size reduction, bandwidth broadening, and drive voltage reduction in optical waveguide devices. In order to reduce the size, miniaturization of a waveguide configuration, for example, by adopting a folded waveguide 2 as shown in FIG. 1 is required. Accordingly, each signal electrode used for modulation, the light-receiving element for monitoring output light, and the like also need to have a finely dense configuration to be capable of being disposed within a limited element area. As a result, positions of input and output portions of the signal electrode and positions of various fixed members are inevitably close to each other, making it easier for the adhesive to flow between the electrodes or to flow from the holding member 5 into an installation part of the light-receiving element 4 compared to the related art.

For example, a distance from the input and output portions of the electrode or the light-receiving element to a bonding position of the holding member is reduced to about ⅕ to 1/7 in an optical modulator with the folded waveguide configuration compared to a modulator (chip in FIG. 2) with a configuration of the related art in which input and output of light are unidirectional. In a case of the unidirectional product in the related art, a distance between an input portion of an electrode and a holding member was about 6 mm, and a distance between a light-receiving element and the holding member was about 0.4 mm. In a case where the folded waveguide is adopted, a distance between an input portion of an electrode and a holding member is about 1 mm, and a distance between a light-receiving element and the holding member is about 0.2 mm.

In addition, since an adverse effect of the adhesive flowing into the signal electrode on the electrical characteristics becomes more significant as a bandwidth increases, the deterioration of the electrical characteristics due to the flow-in of the adhesive is a more serious problem in next-generation optical waveguide devices covering a bandwidth higher than 100 GHz.

### CITATION LIST

### Patent Literature

[Patent Literature No. 1] Japanese Laid-open Patent Publication No. 2005-43402

[Patent Literature No. 2] Japanese Patent No. 6414295

[Patent Literature No. 3] Japanese Laid-open Patent Publication No. 2017-173353

### SUMMARY OF INVENTION

### Technical Problem

An object of the present invention is to solve the above-described problems and to provide an optical waveguide device which is configured such that an adhesive does not flow into a space between electrodes and the like when a fixed member is bonded to a substrate and in which propagation loss of an optical waveguide or the like is reduced. In addition, the object is to provide an optical modulation device and an optical transmission apparatus using the optical waveguide device.

### Solution to Problem

In order to achieve the object, the optical waveguide device, and the optical modulation device and the optical transmission apparatus using the same of the present invention have the following technical features.

(1) An optical waveguide device includes: a substrate on which an optical waveguide is formed; an electrode formed on the substrate; and a fixed member fixed on the substrate through an adhesive, in which a structure protruding on the substrate is disposed in at least one of a space between the fixed member and the electrode and a space between the fixed member and an additional fixed member, and the structure is continuously disposed to divide an upper surface of the substrate into two regions, and a slit that connects the two regions is provided at an intermediate portion of the structure or between the structure and an end portion of the substrate.

(2) In the optical waveguide device according to (1), an opening width of the slit provided at the intermediate portion of the structure is set in a range of 3 μm or more and 10 μm or less.

(3) In the optical waveguide device according to (1), an opening width of the slit provided between the structure and the end portion of the substrate is 10 μm or less.

(4) In the optical waveguide device according to (1), a length of the slit connecting the two regions is 10 μm or more.

(5) In the optical waveguide device according to (1), a cross-sectional shape of the structure perpendicular to a direction in which the structure extends has a ratio of a height of the structure to a length of a base side of the structure less than 3.

(6) In the optical waveguide device according to any one of (1) to (5), a material included in the structure is the same material as a material of the electrode or a material having critical surface tension less than 100 dyn/cm.

(7) In the optical waveguide device according to any one of (1) to (6), a product of an area of the region on the substrate from the fixed member to the structure and a height of the structure is ⅓ or more than a product of an area of a joined portion between the substrate and the fixed member and a thickness of the adhesive in the joined portion.

(8) An optical modulation device includes: the optical waveguide device according to any one of (1) to (7); a case accommodating the optical waveguide device; and an optical fiber through which a light wave is input into the optical waveguide or output from the optical waveguide.

(9) In the optical modulation device according to (8), the optical waveguide device includes a modulation electrode for modulating the light wave propagating through the optical waveguide, and an electronic circuit that amplifies a modulation signal to be input into the modulation electrode of the optical waveguide device is provided inside the case.

(10) An optical transmission apparatus includes: the optical modulation device according to (8) or (9) ; and an electronic circuit that outputs a modulation signal causing the optical modulation device to perform a modulation operation.

### Advantageous Effects of Invention

In the present invention, since an optical waveguide device includes: a substrate on which an optical waveguide is formed; an electrode formed on the substrate; and a fixed member fixed on the substrate through an adhesive, in which a structure protruding on the substrate is disposed in at least one of a space between the fixed member and the electrode and a space between the fixed member and an additional fixed member, and the structure is continuously disposed to divide an upper surface of the substrate into two regions, and a slit that connects the two regions is provided at an intermediate portion of the structure or between the structure and an end portion of the substrate, it is possible to reduce flow of the adhesive used for the fixed member into the electrode or the other fixed member.

Further, the propagation loss of the optical waveguide can be reduced by providing the slit at the intermediate portion of the structure in which the optical waveguide is formed, and the structure does not cause the blade of the dicing saw to clog when cutting the structure into a chip state by providing the slit between the structure and the end portion of the substrate.

### BRIEF DESCRIPTION OF DRAWINGS

FIG. 1 is a plan view showing an optical waveguide device (two chips) having a folded waveguide.

FIG. 2 is a plan view showing an optical waveguide device (two chips) in which a propagation direction of light is unidirectional.

FIG. 3 is a plan view for describing a first example related to the optical waveguide device of the present invention.

FIG. 4 is a plan view for describing a second example related to the optical waveguide device of the present invention.

FIG. 5 is a plan view for describing a slit formed at an intermediate portion of a structure.

FIG. 6 is a plan view for describing a slit formed between the structure and an end portion of a substrate.

FIG. 7 is a cross section view taken along an alternate long and short dash line C in FIG. 5 or 6.

FIG. 8 is a plan view for describing a third example related to the optical waveguide device of the present invention.

FIG. 9 is a plan view for describing an optical modulation device and an optical transmission apparatus using the optical waveguide device of the present invention.

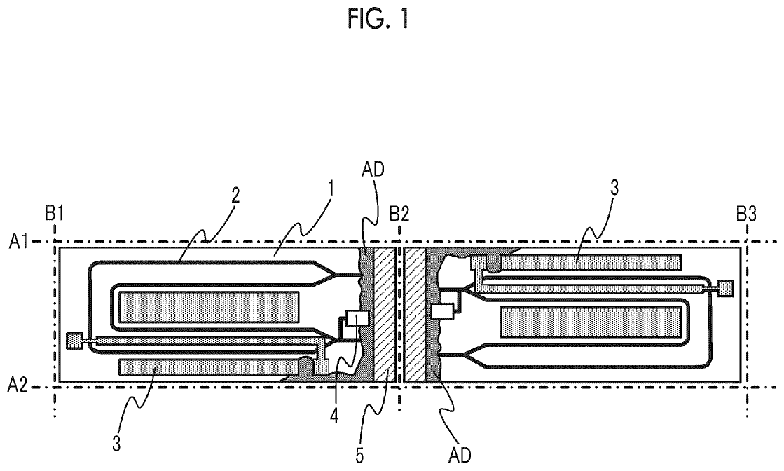

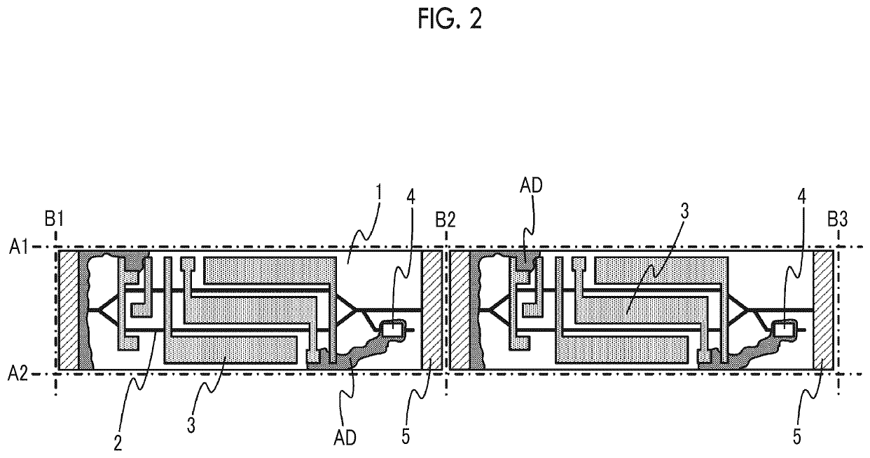

### DESCRIPTION OF EMBODIMENTS

Hereinafter, an optical waveguide device of the present invention will be described in detail using preferred examples.

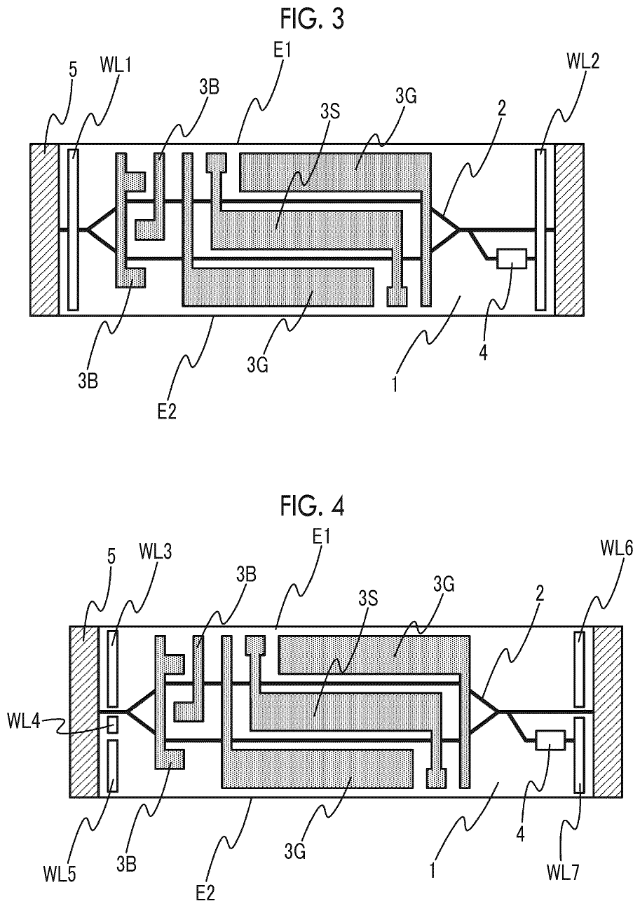

As shown in FIGS. 3 to 8, the optical waveguide device of the present invention includes a substrate 1 on which an optical waveguide 2 is formed, an electrode (3S, 3G, 3B) formed on the substrate, and a fixed member (4, 5) fixed on the substrate through an adhesive, in which a structure (WL1 to WL13) protruding on the substrate is disposed in at least one of a space between the fixed member and the electrode and a space between the fixed member and an additional fixed member, and the structure is continuously disposed to divide an upper surface of the substrate into two regions, and a slit that connects the two regions is provided at an intermediate portion of the structure or between the structure and an end portion (E1, E2) of the substrate.

As a substrate 1 on which the optical waveguide used in the optical waveguide device of the present invention is formed, materials having an electro-optic effect such as a substrate formed of lithium niobate (LN), lithium tantalate (LT), lead lanthanum zirconate titanate (PLZT), or the like, or a vapor-phase growth film formed of these materials can be used.

In addition, various materials such as semiconductor materials, organic materials, or the like can also be used as the optical waveguide.

Furthermore, the “substrate” in the present invention is a concept including not only the substrate having the electro-optic effect but also a “reinforcing substrate” described later.

As a method of forming the optical waveguide 2, a method of forming the optical waveguide 2 by thermally diffusing Ti or the like on an LN substrate or of forming a rib optical waveguide by causing a part corresponding to the optical waveguide to have a protruding shape on a substrate by, for example, etching a part of the substrate 1 other than the optical waveguide or by forming grooves on both sides of the optical waveguide can be used. Furthermore, a refractive index can be further increased by diffusing Ti or the like on a surface of the substrate using a thermal diffusion method, a proton exchange method, or the like in accordance with the rib optical waveguide.

A thickness of the substrate (thin plate) on which the optical waveguide 2 is formed is set to be 10 μm or less, more preferably 5 μm or less, and still more preferably 1 um or less in order to achieve velocity matching between a microwave of a modulation signal and a light wave. The height of the rib optical waveguide is set to 4 μm or less, more preferably 3 μm or less, still more preferably 1 μm or less. In addition, it is also possible to form a vapor-phase growth film on the reinforcing substrate and to process the film to have a shape of the optical waveguide.

The reinforcing substrate is adhesively fixed to a back surface of the substrate 1 on which the optical waveguide is formed, via direct joining or through an adhesive layer of resin or the like in order to increase mechanical strength. As the reinforcing substrate to be directly joined, a substrate including an oxide layer of a material such as crystal, glass, sapphire, or the like that has a lower refractive index than those of the optical waveguide and the substrate on which the optical waveguide is formed, and that has a similar coefficient of thermal expansion to the optical waveguide or the like is preferably used. Composite substrates obtained by forming a silicon oxide layer on a silicon substrate and by forming a silicon oxide layer on an LN substrate, which are abbreviated to SOI and LNOI, can also be used.

In the optical waveguide device of the present invention, a holding member 5 is fixed to the substrate 1 through the adhesive in a portion in which an optical fiber or an optical lens is connected in the end portion of the substrate 1. In addition, a light-receiving element 4 is fixed on the substrate 1 through the adhesive in order to receive a light wave propagating through the optical waveguide or radiated light emitted from a Y-branch coupler of the optical waveguide. These members fixed to the substrate 1 through the adhesive, such as the holding member 5 and the light-receiving element 4, are collectively referred to as the “fixed member”.

A feature of the optical waveguide device of the present invention is that a structure (WL1 and the like) protruding on the substrate 1 is disposed in at least one of a space between the fixed member (4, 5) and the electrode (3S, 3G, 3B) and a space between the fixed member 5 and an additional fixed member 4, and the structure is continuously disposed to divide an upper surface of the substrate into two regions, and a slit that connects the two regions is provided at an intermediate portion of the structure or between the structure and an end portion (E1, E2) of the substrate.

In FIG. 3, slits are formed between the structures (WL1, WL2) and the end portions (E1, E2) of the substrate 1, and in FIG. 4, slits are formed at intermediate portions of the structures (between WL3 and WL4, between WL4 and WL5, and between WL6 and WL7).

In the plan views of the optical waveguide devices shown in FIG. 3 and subsequent drawings, a signal electrode 3S, a ground electrode 3G, and a bias electrode 3B are each shown.

The structure of the present invention is used to prevent adhesive from flowing into a gap (particularly, an input and output portion of an electrode close to the fixed member) between the signal electrode 3S and the ground electrode 3G when the fixed member (4, 5) is bonded to the substrate 1. Therefore, structures (embankments) having a function of preventing the flow-in of the adhesive is formed between the fixed members (4, 5) and the electrodes or the like. These structures (embankments) do not completely separate the space between the fixed members and the electrodes or the like, and a slit is provided at an end portion of the structure (FIG. 3) or at the intermediate portions of the structures (FIG. 4).

In the related art, such as in Patent Literature No. 1, it has been considered that the embankment for preventing the flow-in of the adhesive needs to completely separate the fixed member and the electrode or the like in order to function. However, the present inventors have found that, when conditions for the slit as described below is satisfied, the embankment need not be formed in a portion where it is not desirable to form an embankment, that is, the slits may be provided, and have completed the present invention.

Even in the structure having the slit, it is possible to prevent the adhesive from flowing into the electrode or the like, and it is possible to reduce occurrence of optical absorption loss in the optical waveguide, chipping into the optical waveguide device due to clogging of a blade during chip cutting, and the like, which have been problems in the related art. As a result, it is possible to reduce a characteristic difference of each operation voltage in each signal electrode and prevent a deterioration of electrical characteristics.

A place in which the slit is formed is between the structures (WL1, WL2) and the end portions (E1, E2) of the substrate 1 in FIG. 3, and particularly, it is desirable that the structure is always disposed on a side where the input and output portion of the electrode in the chip is present, and the slit is formed.

In addition, as the place in which the slit is formed, the slit is formed in the intermediate portion of the structure in FIG. 4, particularly in a portion of the optical waveguide 2 (between WL3 and WL4). It is needless to say the slit may be formed in a place other than the optical waveguide (between WL4 and WL5). In a case where the slit between WL4 and WL5 is provided, it is possible to mitigate internal stress generated between the structure and the substrate 1 because of a thermal expansion difference due to a difference in linear expansion coefficients of the structure and the substrate 1 as compared with a case of a configuration with one structure WL3.

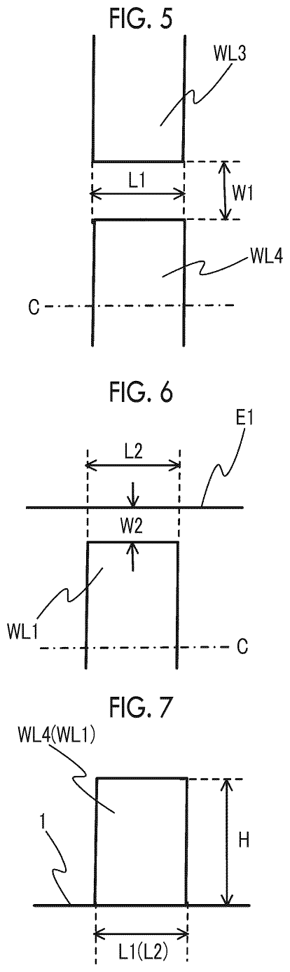

As shown in FIG. 5, in the slit, it is possible to prevent the adhesive from flowing out by appropriately setting a slit opening width (a clearance between the structures) W1 and a slit length (a length of the slit connecting the two regions divided by the structure) L1.

The slit width W1 depends on viscosity of the adhesive and a critical surface tension of each member, but in a general adhesive used for fixing a fixed member (such as a holding member or the like), the slit width at which the flow-in reliably does not occur is required to be 10 μm or less, more preferably 7 μm or less, and still more preferably 5 μm or less.

On the other hand, in a case where the slit is formed in a portion where the optical waveguide and the structure intersect with each other, such as between WL3 and WL4 in FIG. 4, when the slit width W1 is not 3 μm or more, it is impossible to take a sufficient clearance with respect to the optical waveguide, which causes an adverse effect on optical propagation characteristics.

The length L1 of the slit depends on the slit width, but when the length L1 is 10 μm or more, more preferably 15 μm or more, and still more preferably 20 μm, the flow of the adhesive can be more completely prevented.

As shown in FIGS. 3 and 6, in a case where the slit is formed between the structure (embankment) and the end portion (E1, E2) of the substrate 1, a slit width W2 is 10 um or less, similarly to the above-described slit width W1, and is more preferably 7 μm or less or 5 μm or less. The fixing of the fixed member is often performed before the cutting into chips, and in this case, it is preferable that a clearance (a clearance twice the width W2 in FIG. 6) between the structures formed on the adjacent chips, excluding the cut margin (a portion cut off in the case of cutting) cut by the cutting blade, is 10 μm or less. However, in a case where the length of the slit is increased or in a case where the slit is away from the electrode or the like, the clearance may be set to be wider than 10 μm. In addition, it is also required to note that if the clearance between the above-described structures is made too narrow, it becomes difficult to perform the cutting within the slit because of device-side positional accuracy issues during chip cutting with a dicing saw.

FIG. 7 is a cross section view of the structure taken along an alternate long and short dash line C in FIG. 5 or FIG. 6. A cross-sectional shape of the structure perpendicular to a direction in which the structure extends depends on a material used for the structure and joint strength between the structure and the substrate 1, but from the viewpoint of ensuring mechanical strength of the structure, the cross-sectional shape has a ratio of a height H to the length L1 (L2) of a base side of the structure (H/L1) less than 3.

The material included in the structure (embankment) is not particularly limited and may be the same as the material used for the electrode. As a result, since the structure can also be formed at a time of forming the electrode, a manufacturing process is simplified, and additionally, by using the same metal as the electrode, such as Au, Cu, Al, Ag, or the like, the structure can also be used for removing unnecessary light. In addition, since the structure can also be used as a part of a ground electrode, the structure has high versatility.

In order to enhance the effect of preventing the flow-in of the adhesive, a material with low critical surface tension (for example, a resin material) can also be used for the structure. By using a material with a low critical surface tension, for example, less than 100 dyn/cm, compared to an inorganic material such as metal, glass, or the like, it is possible to increase interfacial tension with the adhesive which is a liquid, making it less likely for the adhesive to flow into the slit.

A type of the adhesive for fixing the fixed member is not limited as long as the fixed member and the substrate 1 are firmly bonded to each other, but a thermosetting or UV-curable resin adhesive (acrylic, urethane, epoxy, thiol, or silicone) is preferable. The viscosity of the adhesive is preferably in a range of 100 mPa·s to 3000 mPa·s. In a case where the viscosity is low, the adhesive is likely to flow into the slit, and in a case where the viscosity is high, workability is poor and it is difficult to form the adhesive uniformly and thinly.

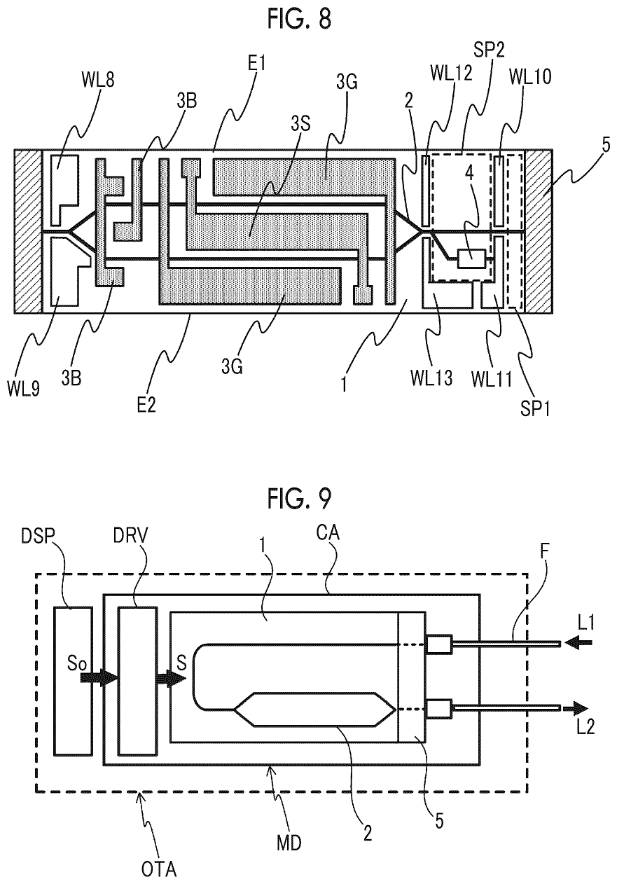

In a case where the structure is formed of a metal, as shown in the structure WL9 in FIG. 8, the structure can be disposed along the optical waveguide 2, and a function of removing unnecessary light propagating through the optical waveguide can be added.

In FIG. 8, the structures WL10 and WL11 prevent the adhesive from flowing from the holding member 5 into a light-receiving element 4 side, and the structures WL12 and WL13 prevent the adhesive from flowing from the light-receiving element 4 into the electrodes (3S, 3G). Further, the slit between the structure WL11 and the structure WL13 mitigates the internal stress due to the thermal expansion difference.

A dotted line frame SP1 is a storage region for the adhesive which is formed between the holding member 5 and the structures WL10 and WL11. In addition, A dotted line frame SP2 is a storage region for the adhesive which includes the structures WL10 to WL13 (excluding a portion where the light-receiving element 4 is disposed).

An amount of adhesive that can be stored in the storage region is defined by a product of an area of the region and the height of the structure.

In general, an amount of adhesive dropped is approximately 1.5 times a required volume of the adhesive layer on a chip surface at a fixed member bonding position. A bonding fixed member is placed on the dropped adhesive solution, and the member is pressurized to spread the adhesive until the thickness of the adhesive layer becomes a predetermined value. An amount of adhesive flowing out of the member is approximately ⅓ of the amount of adhesive dropped. By setting the stored amount, which is the product of the area of the storage region (a region from the fixed member to the structure on the substrate) and the height of the structure, to be ⅓ or more than the used amount of the adhesive layer, which is a product of an area of the joined portion between the substrate and the fixed member and a thickness of the adhesive in the joined portion, it is possible to reliably store the adhesive that has flowed out around the fixed member in the storage region.

The optical waveguide device of the present invention is provided with a modulation electrode that modulates the light wave propagating through the optical waveguide 2 in the substrate 1 and is accommodated inside a case CA as shown in FIG. 9. Furthermore, an optical modulation device MD can be configured by providing an optical fiber (F) through which the light wave is input into the optical waveguide or output from the optical waveguide. In FIG. 9, the optical fiber is introduced into the case through a through-hole that penetrates a side wall of the case, and is directly joined to the optical waveguide device. The optical waveguide device and the optical fiber can also be optically connected through a space optical system.

An optical transmission apparatus OTA can be configured by connecting, to the optical modulation device MD, an electronic circuit (digital signal processor DSP) that outputs a modulation signal So causing the optical modulation device MD to perform a modulation operation. A modulation signal S to be applied to the optical waveguide device is required to be amplified. Thus, a driver circuit DRV is used. The driver circuit DRV and the digital signal processor DSP can be disposed outside the case CA or can be disposed inside the case CA. Particularly, disposing the driver circuit DRV inside the case can further reduce the propagation loss of the modulation signal from the driver circuit.

### Industrial Applicability

As described above, according to the present invention, it is possible to provide an optical waveguide device which is configured such that an adhesive does not flow into a space between electrodes and the like when a fixed member is bonded to a substrate and in which propagation loss of an optical waveguide or the like is reduced. In addition, it is possible to provide an optical modulation device and an optical transmission apparatus using the optical waveguide device.

### Reference Signs List

1: substrate (thin plate, film body) on which optical waveguide is formed
2: optical waveguide
3: electrode
4: light-receiving element
5: holding member
AD: adhesive
WL1 to WL13: structure (embankment)

1. An optical waveguide device comprising:
a substrate on which an optical waveguide is formed;
an electrode formed on the substrate; and
a fixed member fixed on the substrate through an adhesive,
wherein a structure protruding on the substrate is disposed in at least one of a space between the fixed member and the electrode and a space between the fixed member and an additional fixed member, and
the structure is continuously disposed to divide an upper surface of the substrate into two regions, and a slit that connects the two regions is provided at an intermediate portion of the structure or between the structure and an end portion of the substrate.

2. The optical waveguide device according to claim 1,
wherein an opening width of the slit provided at the intermediate portion of the structure is set in a range of 3 μm or more and 10 μm or less.

3. The optical waveguide device according to claim 1,
wherein an opening width of the slit provided between the structure and the end portion of the substrate is 10 μm or less.

4. The optical waveguide device according to claim 1,
wherein a length of the slit connecting the two regions is 10 μm or more.

5. The optical waveguide device according to claim 1,
wherein a cross-sectional shape of the structure perpendicular to a direction in which the structure extends has a ratio of a height of the structure to a length of a base side of the structure less than 3.

6. The optical waveguide device according to claim 1,
wherein a material included in the structure is the same material as a material of the electrode or a material having critical surface tension less than 100 dyn/cm.

7. The optical waveguide device according to claim 1,
wherein a product of an area of the region on the substrate from the fixed member to the structure and a height of the structure is ⅓ or more than a product of an area of a joined portion between the substrate and the fixed member and a thickness of the adhesive in the joined portion.

8. An optical modulation device comprising:
the optical waveguide device according to claim 1;
a case accommodating the optical waveguide device; and
an optical fiber through which a light wave is input into the optical waveguide or output from the optical waveguide.

9. The optical modulation device according to claim 8,
wherein the optical waveguide device includes a modulation electrode for modulating the light wave propagating through the optical waveguide, and
an electronic circuit that amplifies a modulation signal to be input into the modulation electrode of the optical waveguide device is provided inside the case.

10. An optical transmission apparatus comprising:
the optical modulation device according to claim 8; and
an electronic circuit that outputs a modulation signal causing the optical modulation device to perform a modulation operation.
